(19) United States
(12) Patent Application Publication
(10) Pub. No.: US 2025/0290691 A1
(43) Pub. Date: Sep. 18, 2025

(54) DUAL-MIXED REFRIGERANT PRECOOLING PROCESS

(71) Applicants: Qatar Foundation for Education, Science and Community Development, Doha (QA); Qatar University, Doha (QA)

(72) Inventors: Ahmad K. Sleiti, Doha (QA); Wahib A. Al-Ammari, Doha (QA)

(21) Appl. No.: 18/861,100

(22) PCT Filed: Apr. 28, 2023
(86) PCT No.: PCT/QA2023/050004

§ 371 Date: Oct. 28, 2024

Related U.S. Application Data
(60) Provisional application No. 63/336,565, filed on Apr. 29, 2022.

(51) Int. Cl. F25J 1/02; F25J 1/00

(52) U.S. Cl. CPC F25J 1/0214; F25J 1/001; F25J 1/0092; F25J 1/0097

(57) ABSTRACT

A dual-mixed refrigerant precooling process for high capacity hydrogen liquefaction plants in which two mixed refrigerants are used to perform the precooling process. Each mixed refrigerant is circulated in a separate loop such that the first mixed refrigerant provides the cold duty of the first head exchange and the second heat exchanger, while the second refrigerant mixture provides the cold duty of a third heat exchanger and a fourth heat exchanger.

### CROSS-REFERENCE TO RELATED APPLICATION

The present disclosure claims priority to U.S. Provisional Patent Application 63/336,565 having a filing date of Apr. 29, 2022, the entirety of which is incorporated herein.

### BACKGROUND

Liquid hydrogen is a superior alternative for the current energy carries as it has higher energy density (on mass basis ˜120 MJ/kg) and cleanliness. The transition to the hydrogen as the fuel of the future is imposed by the severe global warming problem that threatens the survival and development of mankind. Liquid hydrogen (LH2) enables the transport of hydrogen over extended distances in a cost-effective way more than the compressed gas, which may unlock new large-scale applications in industrial trade, maritime, mobility, and industry. However, despite the source of the hydrogen gas, its liquefaction process is highly cost intensive and consumes large amount of energy for operation. The existing hydrogen liquefaction plants consume about 10-13 kWh/kgLH2 at capacities between 5 to 35 TPD (tons per day). All of these plants use the precooled Claude system as developed 55 years ago with minor improvements. Other conceptual large-scale liquefaction processes were proposed that consume 6 to 11 kWh/kgLH2 (which means 20% to 33% of the energy carried by the produced LH2 is consumed) at capacities between 170 TPD to 300 TPD. However, these processes are still energy intensive, suffer from complexity, and need significant further improvements in the selection of their mixed refrigerants. This is essential step to make the LH2 commercially competitive to the liquid natural gas (LNG) from energetic and economic point of views.

### SUMMARY

The present disclosure generally relates to a precooling process of hydrogen in the liquefaction plants is energy intensive process consuming tremendous portion of about 30% of the total compression power of the plant. Several previous studies introduced various pure-refrigerant and single mixed refrigerant (“SMR”) precooling processes, however, their specific energy consumption (“SEC”) still very high especially at large-scale capacities. Therefore, needed is a novel, efficient, and large scale dual-mixed refrigerant (“DMR”) process to precool the hydrogen from 25° C. to −192° C. at pressure of 21 bar. New heavyweight-based mixed refrigerant “MR1” and lightweight-based mixed refrigerant “MR2” are developed for the DMR process using new-proposed systematic approach. The proposed DMR process is capable of handling a wide range of hydrogen flow from 100 TPD to 1000 TPD with SEC of 0.862 kWh/kgH2Feed, which is 20.33% lower than the most competitive SMR process available in literature. Based on the sensitivity analysis, further optimization of the DMR operating parameters reduced the SEC to 0.833 kWh/kgH2Feed at capacity of 500 TPD. In addition, the exergy efficiency of the new precooling process is improved by 6.14% compared to the best available SMR reference process. Furthermore, the COP of the new process is improved by 14.47% and the total annualized cost is reduced by 12.24%. Compared to five other technologies that use the pure-refrigerant and other SMR precooling processes, the DMR reduces the SEC by 39.0% to 63.0%.

In light of the disclosure herein and without limiting the disclosure in any way, in a first aspect of the present disclosure, which may be combined with any other aspect listed herein unless specified otherwise, a process for hydrogen liquefaction includes providing a first cooling loop with a first mixed refrigerant and providing a second cooling loop with a second mixed refrigerant.

In another aspect of the present disclosure, which may be used in combination with any other aspect or combination of aspects listed herein, the first cooling loop comprises at least a first heat exchanger and a second heat exchanger.

In another aspect of the present disclosure, which may be used in combination with any other aspect or combination of aspects listed herein, the second cooling loop comprises at least a third heat exchanger and a fourth heat exchanger.

In another aspect of the present disclosure, which may be used in combination with any other aspect or combination of aspects listed herein, the first cooling loop comprises at least a first cooler and a second cooler.

In another aspect of the present disclosure, which may be used in combination with any other aspect or combination of aspects listed herein, the second cooling loop comprises at least a third cooler, a fourth cooler, and a fifth cooler.

In another aspect of the present disclosure, which may be used in combination with any other aspect or combination of aspects listed herein, the first cooling loop comprises at least a first expansion valve and a second expansion valve.

In another aspect of the present disclosure, which may be used in combination with any other aspect or combination of aspects listed herein, the second cooling loop comprises at least a third expansion valve and a fourth expansion valve.

In another aspect of the present disclosure, which may be used in combination with any other aspect or combination of aspects listed herein, the first cooling loop comprises at least a first mixed refrigerant compressor and a second mixed refrigerant compressor.

In another aspect of the present disclosure, which may be used in combination with any other aspect or combination of aspects listed herein, the second cooling loop comprises at least a third mixed refrigerant compressor, a fourth mixed refrigerant compressor, and a fifth mixed refrigerant compressor.

In another aspect of the present disclosure, which may be used in combination with any other aspect or combination of aspects listed herein, the first cooling loop comprises at least a first mixer.

In another aspect of the present disclosure, which may be used in combination with any other aspect or combination of aspects listed herein, the second cooling loop comprises at least a second mixer.

In another aspect of the present disclosure, which may be used in combination with any other aspect or combination of aspects listed herein, the first cooling loop comprises at least a first separator.

In another aspect of the present disclosure, which may be used in combination with any other aspect or combination of aspects listed herein, the second cooling loop comprises at least a second separator.

In another aspect of the present disclosure, which may be used in combination with any other aspect or combination of aspects listed herein, the first mixed refrigerant comprises at least one of methane, ethane, propane, n-butane, i-pentane, n-pentane, nitrogen, hydrogen, ethylene, R-14, or ammonia.

In another aspect of the present disclosure, which may be used in combination with any other aspect or combination of aspects listed herein, the second refrigerant comprises at least one of methane, ethane, propane, n-butane, i-pentane, n-pentane, nitrogen, hydrogen, ethylene, R-14, or ammonia.

In another aspect of the present disclosure, which may be used in combination with any other aspect or combination of aspects listed herein, the first mixed refrigerant has a heavier molecular weight than the second mixed refrigerant.

In another aspect of the present disclosure, which may be used in combination with any other aspect or combination of aspects listed herein, the first mixed refrigerant is in a vapor phase and liquid phase in the first cooling loop.

In another aspect of the present disclosure, which may be used in combination with any other aspect or combination of aspects listed herein, the second mixed refrigerant is in a vapor phase and a liquid phase in the second cooling loop.

Additional features and advantages are described herein, and will be apparent from the following Detailed Description and the figures.

### BRIEF DESCRIPTION OF THE FIGURES

FIG. 1 illustrates a flowchart of the proposed dual-mixed refrigerant (“DMR”) process, including both a precooling and a liquefaction process.

FIG. 2 illustrates a flowchart of the proposed dual-mixed refrigerant precooling process.

FIG. 3 illustrates a table of a chemical composition on a Molar basis for a proposed DMR process.

FIG. 4 illustrates a table of various chemical compositions on a Molar basis for proposed DMR process and tested performance indicators.

FIG. 5 is a graph illustrating the effect of the hydrogen flow feed rate on the performance indicators of the proposed DMR process.

FIG. 6 is a graph illustrating the effect of the high-pressure of a first mixed refrigerant (“MR1”) on the performance indicators of the proposed DMR process.

FIG. 7 is a graph illustrating the effect of the high-pressure of a second mixed refrigerant (“MR2”) on the performance indicators of the proposed DMR process.

FIG. 8 is a graph illustrating the effect of the low-pressure of MR1 on the performance indicators of the proposed DMR process.

FIG. 9 is a graph illustrating the effect of the low-pressure of MR2 on the performance indicators of the proposed DMR process.

FIG. 10 illustrates composite curves relating to the four heat exchangers in the proposed DMR process.

FIG. 11 illustrates a comparison of performance indicators between the proposed DMR process and a prior art process.

FIG. 12 illustrates a comparison between the proposed DMR process and other prior art processes used for hydrogen precooling.

FIG. 13 includes a table of definitions of the fuel exergy and product exergy of the equipment of the proposed DMR process.

FIG. 14 is a pie chart illustrating the contribution of the equipment in the total exergy product of the proposed DMR process.

FIG. 15 is a pie chart illustrating the contribution of the equipment in the total exergy destruction of the proposed DMR process.

FIG. 16 is a graph illustrating the comparison between the proposed DMR process and the Reference SMR process in terms of the total capital investment, grass root cost, and the total annualized cost.

FIG. 17 illustrates a comparison of CO2 emissions if the proposed DMR process and other precooling processes are driven by fossil-fuel-based electricity.

### DETAILED DESCRIPTION

A hydrogen liquefaction process is mainly composed of two major stages, namely the precooling process, and the liquefaction process. Special focus is given to the precooling process because it is the stage with most degrees of freedom in the design and consumes more than 30% of the overall compression power.

Typically in the precooling stage, hydrogen feed gas is cooled from 25° C. to −193° C. Known precooling cycles include: (1) nitrogen precooled cycles; (2) helium precooled cycles; (3) liquefied natural gas (“LNG”) precooled cycles; (4) Joule-Brayton (“J-B”) precooled cycles; (5) Joule-Thomson precooled cycles; and (6) mixed refrigerant (“MR”) precooled cycles. As used herein, “mixed refrigerants” means a compound including several chemical compositions that is capable of transitioning between liquid and gas. Of these precooling cycles, the MR precooled cycles precool the hydrogen feed gas and the mixed refrigerants with minimal compression power (with a suitable mixed refrigerant) and the precooling process could reach a temperature of −198° C. Thus, the MR cycles can potentially achieve lower energy consumption without losing their configuration simplicity. To improve the performance of the MR precooling cycles, new configurations with new mixed refrigerants are introduced in this disclosure.

Many MR precooling cycles known in the art utilize a single mixed refrigerant (“SMR”). However, the SMR limits the performance improvements of the heat exchangers in the precooling stage. Also, it contains a sizeable portion of lightweight refrigerants, which increase the compression power. Significant improvements on the performance of the MR precooling process could be achieved by applying a dual-mixed refrigerants (“DMR”) for the precooling stage. With proper selection of the mixed refrigerants, the DMR process will potentially achieve superior performance compared to the SMR processes from energetic, exergetic, and economic point of views.

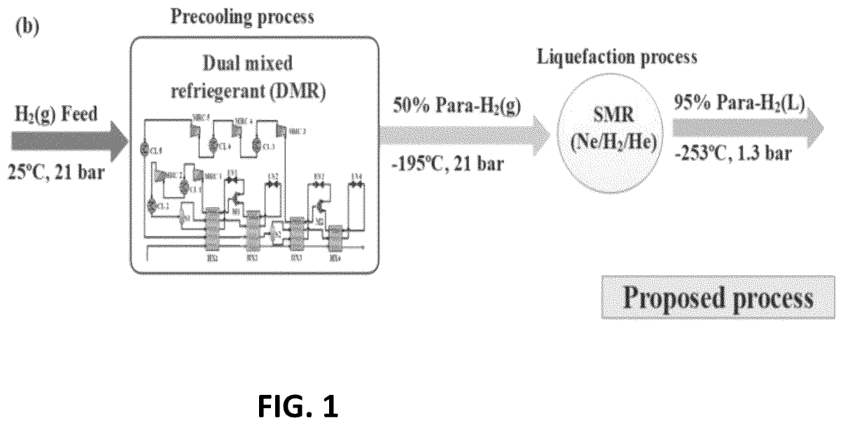

The present disclosure provides a dual-mixed refrigerant precooling process for high capacity hydrogen liquefaction plants in which two mixed refrigerants are used to perform the precooling process. The present process provides a number of advantages, including, for example: (1) the use of expansion valves rather than expanders for the throttling process in the present DMR process to avoid using moving parts (the expanders) at cryogenic temperatures resulting in high reliable system and easy to scale-up; (2) replacement of the existing conventional and the SMR precooling processes used in hydrogen liquefaction plants; (3) development of new mixed refrigerants for the proposed process that achieve extraordinary performance from energetic and exergetic point of view; and (4) development of systematic and new methodology for mixing refrigerants for the precooling process of hydrogen liquefaction. In this process as shown in FIG. 1, the precooling process reduces the temperature of the feed hydrogen from 25° C. to a temperature of −195° C. at the feed pressure of 21 bar. Then, the liquefaction process cools the hydrogen further from −195° C. to −253° C. at an outlet pressure of 1.3 bar.

As used herein, “SEC” means specific energy consumption. The SEC is calculated by dividing the net total compression power of the precooling process by the mass flow rate of the hydrogen feed as:

$$S E C = \frac{\sum {\dot{W}}_{MRC , i} - \sum {\dot{W}}_{Exp , i}}{{\dot{m}}_{H F}}$$

where Σ\dot{W}_{MRC,i} is the total compression power of all mixed refrigerant compressors, Σ\dot{W}_{Exp,i} is the total power generated by the liquid expanders, and \dot{m}_{HF} is the flow rate of the hydrogen feed stream.

As used herein, “COP” means coefficient of performance. The COP is defined as:

$$COP = \frac{\sum {Q}_{HX , CD}}{\sum {\dot{W}}_{MRC , i} - \sum {\dot{W}}_{Exp , i}}$$

where ΣQ_{HX,CD} is the total cold duty of all heat exchangers.

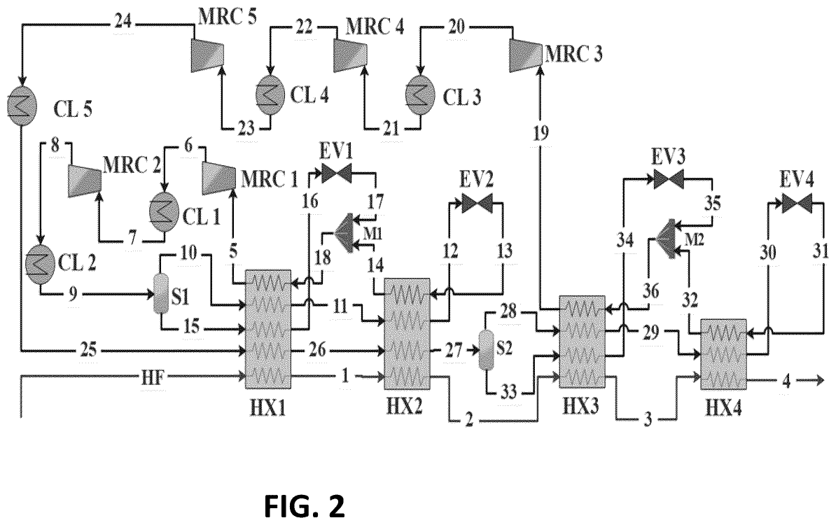

A closer view of the precooling process is shown in FIG. 2. FIG. 2 illustrates a DMR precooling process including a first mixed refrigerant (“MR1”) and a second mixed refrigerant (“MR2”). In this system, the temperature of the feed hydrogen is reduced from the ambient temperature (25° C.) to a temperature of −195° C. at a feed pressure of 21 bar. Each mixed refrigerant is circulated in a separate loop such that the first mixed refrigerant (“MR1”) provides the 18.71 MW cold duty of a first heat exchanger (“HX1”) and the 9.16 MW cold duty of a second heat exchanger (“HX2,”) while the second mixed refrigerant (“MR2”) provides the 14.44 MW cold duty of a third heat exchanger (“HX3”) and the 5.11 MW cold duty of a fourth heat exchanger (“HX4”). The feed hydrogen passes through each heat exchanger in 1-4. It can be noted that the first two heat exchangers (HX1 and HX2) have higher cooling duty than of HX3 and HX4. This is because that HX1 and HX2 are responsible to: (1) cool the hydrogen stream from 25° C. to −53° C.; (2) cool the MR2 stream from 21° C. to −53° C.; (3) cool the liquid stream of MR1 from 21° C. to 23° C.; and (4) cool the vapor stream of MR1 from 21° C. to −53° C. While the other two heat exchangers (HX3 and HX4) are responsible to: (1) cool the hydrogen stream from −53° C. to −192° C.; (2) cool the liquid stream of MR2 from −53° C. to −140° C.; and (3) cool the vapor stream of MR2 −53° C. to −192° C. The heat exchangers can be any device or reactor suitable to cool the hydrogen feed to the appropriate temperatures. As one such example, the heat exchanger may be a plate heat exchanger. It is worth mentioning that the values of the optimum temperatures above were reached via a rigorous iterative process by observing and correcting the composite curves of all heat exchangers.

Next, at the design point conditions of the proposed process, the MR1 is compressed from 3.1 bar to 11.9 bar through two-stage intercooled compression process (5-9). In the first stage, the feed passes through a first mixed refrigerant compressor (“MRC1”) at 5-6 and a first cooler (“CL1”) at 6-7. In the second stage, the feed passes through a second refrigerant compressor (“MRC2”) at 7-8 and a second cooler (“CL2”) at 8-9. A mixed refrigerant compressor can be any device or reactor suitable to compress MR1. As one such example, the cooler may be a piston refrigerant compressor. A cooler can be any device or reactor suitable to cool the incoming feeds. As one such example, the cooler may be a commercial cooler or refrigeration system.

At state 9, the MR1 is separated into vapor-phase mixture (10) and liquid-phase mixture (15). The separator can be any device or reactor suitable to extract the different phase states of MR1. As one such example, the separator may be a vapor-liquid separator. The vapor-phase mixture at stream 10 is then passed through HX1 (10-11) and HX2 (11-12) to expand through an expansion valve (“EV2”) at 12-13. Then, the MR1 vapor-phase mixture performs an evaporation process in HX2 (13-14). Simultaneously, the liquid-phase mixture at stream 15 is passed through HX1 (15-16), expands in another expansion valve (“EV1”) at 16-17, and is mixed with the MR1 vapor-phase stream 14 in a mixer (“M1”) to perform the evaporation process in HX1 and then is directed back to the inlet of MRC1 (18-5). The mixer can be any device or reactor suitable to combine the different phase states of MR1. As one such example, the mixer may be a gas-liquid reactor.

Similarly, the MR2 is compressed from 4.7 bar to 39.0 bar through three-stage intercooled compression process (19-25). In the first stage, the feed passes through a third mixed refrigerant compressor (“MRC3”) at 19-20 and a third cooler (“CL3”) at 20-21. In the second stage, the feed passes through a fourth refrigerant compressor (“MRC4”) at 21-22 and a fourth cooler (“CL4”) at 22-23. In the third stage, the feed passes through a fifth refrigerant compressor (“MRC5”) at 23-24 and a fifth cooler (“CL5”) at 24-25.

Once the compression process is complete, the MR2 enters HX1 at 21° C. and is cooled down to a temperature of −23° C. through HX1 (25-26) and to a temperature of −53° C. through HX2 (26-27). Then, like the MR1, the MR2 is separated into vapor-phase mixture (28) and liquid-phase mixture (33) by a separator (“S2”). The vapor-mixture of MR2 (28) is passed through HX3 (28-29) and HX4 (29-30). It then expands through another expansion valve (“EV4”) at 30-31 and perform the evaporation process in HX4 (31-32). Also, the liquid-mixture (33) is passed through HX3 (33-34), expands in another expansion valve (“EV3”) at 34-35, and is mixed with stream 32 in a mixer (“M2”) to perform the evaporation process of HX3. Finally, the MR2 is directed back to the inlet of MRC3 (36-19).

In the present disclosure, the composition of the mixed refrigerants may include: (1) methane; (2) ethane; (3) propane; (4) i-pentane; (5) n-pentane; (6) nitrogen; (7) ethylene; or (8) ammonia. In some embodiments, the composition of MR1 and MR2 may be the same and in other embodiments, the composition of MR1 and MR2 may be different. Several examples of mixed refrigerant materials are described in greater detail below. It will be appreciated that the mixed refrigerants listed above are purely exemplary and other suitable mixed refrigerants may exist.

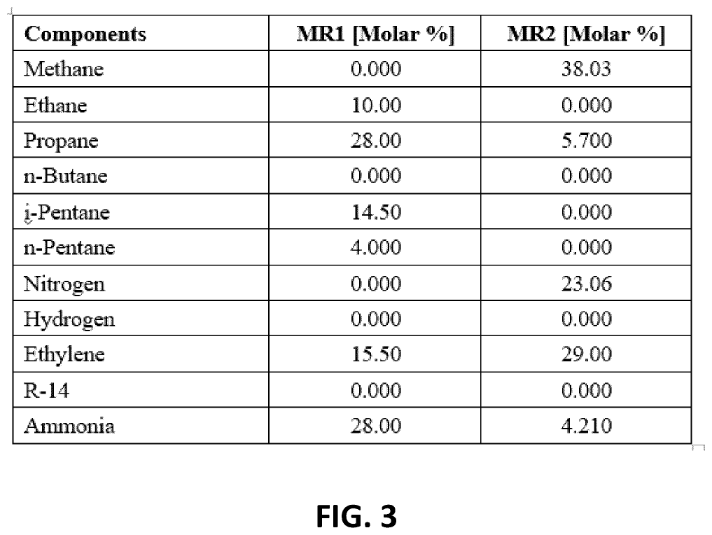

In the embodiment shown in FIG. 3, MR1 comprises 10% ethane, 28% propane, 14.5% i-pentane, 4% n-pentane, 15.5% ethylene, and 28% ammonia by molar concentration. MR2 comprises 38.03% methane, 5.7% propane, 23.06% nitrogen, 29% ethylene, and 4.21% ammonia. The composition of MR1 contains significant part of ammonia (28%), which is also contained in the composition of MR2 as a minor refrigerant (4.21%). The existence of ammonia in MR1 and MR2 improves the heat flow rate per unit mass in HX1 and HX3, which reduces the total required flow rates and thus the compression power is reduced.

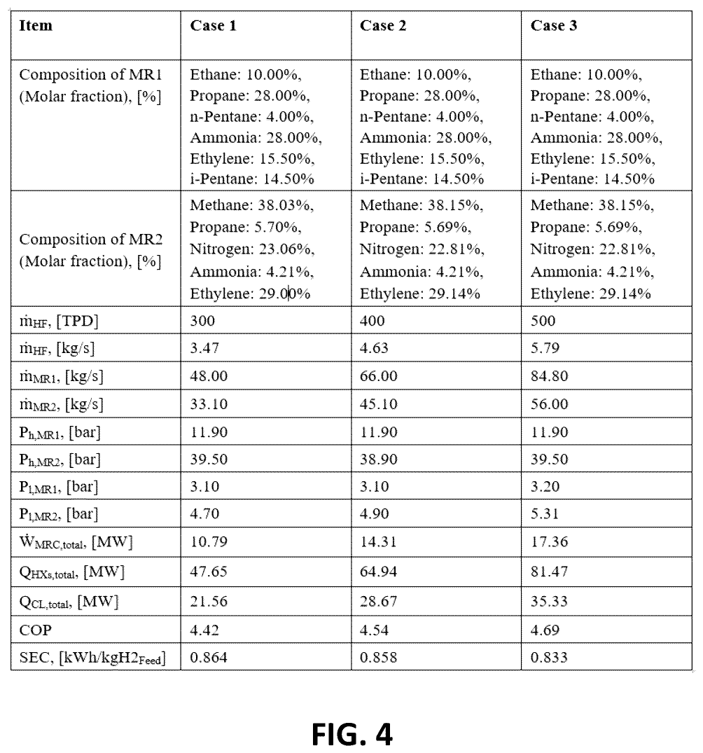

Three other compositions of MR1 and MR2 were tested and summarized in FIG. 4. FIG. 4 shows a preliminary optimization for the composition of MR1 and MR2 of the present DMR process and their operational parameters at three different capacities (Case 1: 300 TPD, Case 2: 400 TPD, and Case 3: 500 TPD). All cases have the same composition for MR1 while the composition of MR2 in Case 2 and Case 3 differs from Case 1 (by slightly increasing the fractions of the methane and ethylene with slight decrease in the nitrogen and propane fractions). The other parameters were adjusted close to their optimum values noted through the sensitivity analysis. It is found that Case 3 operates at higher capacity (500 TPD) with lower SEC and higher COP than in Case 1 and Case 2 by an average of 3.26% and 4.40%, respectively. From the sensitivity analysis, it is clear that the present DMR process needs further work to optimize the SEC without reducing the COP of the process. Thus, MR1 and MR2 compositions that optimize the SEC without reducing the COP are considered by this disclosure.

Specific attention is brought to the fact that MR1 or MR2 do not contain any amounts of n-butane, hydrogen, or R-14 refrigerant liquid according to an embodiment. These materials are commonly found in SMR processes, but are omitted from this system according to an embodiment. It is noted that these components increase the compression power without significant improvement in the composite curves of the heat exchangers; therefore, they are removed from the composition of MR1 and MR2.

Additionally, because the loads of HX1 and HX2 are higher than HX3 and HX4, the composition of the MR1 should be consisted of heavy molecular weight mixed refrigerants (such as propane, n-pentane, ammonia, etc.) to match higher cooling loads at low desired temperature. In contrast, the composition of MR2 should include light mixed refrigerants (such as methane, nitrogen, ethylene, etc.) to provide the extremely low temperatures required in HX3 and HX4. This efficiently reduces the compression power and subsequently the specific energy consumption of the process.

The sensitivity of the proposed DMR process is analysed against five operating parameters including the flow rate of the feed hydrogen (“\dot{m}_{HF}”), the high-pressure of MR1 (“P_{h,MR1}”), the high-pressure of MR2 (“P_{h,MR2}”), the low-pressure of MR1 (“P_{l,MR1}”), and the low pressure of MR2 (“P_{l,MR2}”). The sensitivity of the proposed DMR process is evaluated using three performance indicators: compression power, SEC, and COP. During the analysis of the five mentioned parameters, only one parameter is changed, and the other parameters kept fixed at the design point conditions (presented in FIG. 3) except the flow rates of MR1 and MR2. For each simulated parameters, the flow rates of MR1 and MR2 are adjusted until the composite curves of the heat exchangers match those obtained at the design conditions.

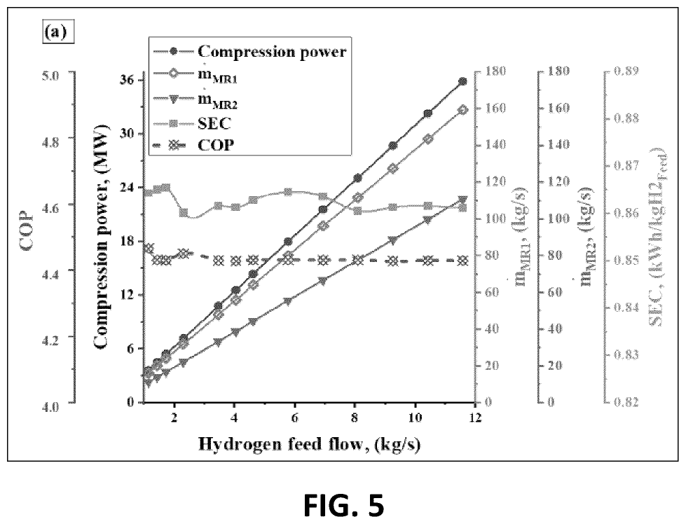

FIG. 5 shows the relationship between the \dot{m}_{HF} and the performance indicators of the proposed DMR process. It is found that the flow rates of MR1 (“\dot{m}_{MR1}”), MR2 (“\dot{m}_{MR2}”), and the compression power linearly increase as \dot{m}_{HF} increases from 1.16 kg/s (100 TPD) to 11.57 kg/s (1000 TPD). In addition, the slope of \dot{m}_{MR1} curve is higher than of \dot{m}_{MR2} curve which minimizes the compression power as the high-pressure of MR1 (11.9 bar) is lower than of MR2 (39.0 bar). Furthermore, over the range of \dot{m}_{HF}, the SEC and COP are slightly changing around 0.863 kWh/kgH2Feed and 4.43, respectively. A maximum SEC of 0.865 kWh/kgH2Feed is noted at \dot{m}_{HF} of 1.74 kg/s (150 TPD) and a minimum SEC of 0.860 is noted at \dot{m}_{HF} of 8.10 kg/s (700 TPD), which is only 0.58% lower than the maximum one. This proves that the composition of the new mixed refrigerant mixtures (MR1 and MR2) can handle different capacities without losing the efficient performance on the heat exchanger and enjoy semi-constant SEC and COP.

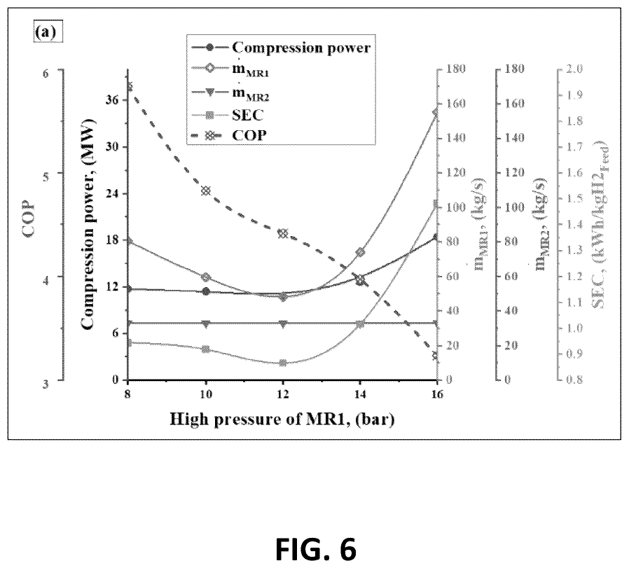

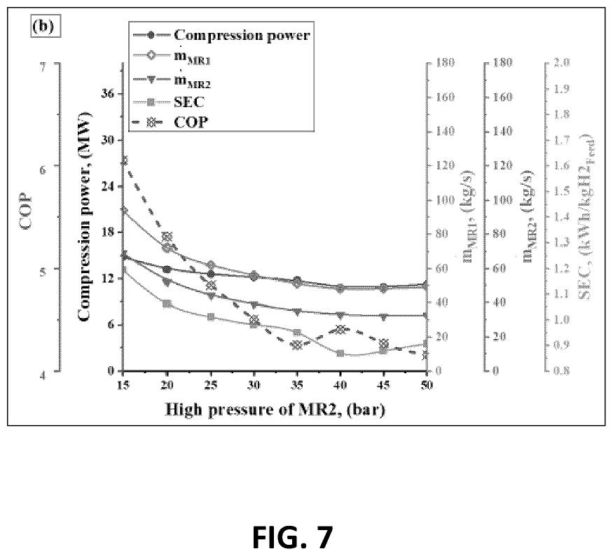

Unlike the effect of \dot{m}_{HF}, the high-pressures of MR1 (P_{h,MR1}) and MR2 (P_{h,MR2}) have significant effects on the performance of the DMR process as shown in FIG. 6 and FIG. 7, respectively. From FIG. 6, it can be noted that changing the P_{h,MR1} does not affect the flow rate of MR2 as the temperature set of the heat exchangers does not change; thus \dot{m}_{MR2} is kept constant. As P_{h,MR1} increases from 8.0 to 16.0 bar, the SEC first decreases from 0.944 kWh/kgH2Feed (at 8.0 bar) to a minimum value of 0.866 kWh/kgH2Feed (at 12.0 bar) then increases up to a maximum value of 1.482 kWh/kgH2Feed (at 16.0 bar). In contrast, as shown in FIG. 7, the increase of P_{h,MR2} from 15.0 bar to 50.0 bar decreases both \dot{m}_{MR1}, and \dot{m}_{MR2} which minimizes the SEC from 1.194 1.482 kWh/kgH2Feed (at 15.0 bar) to a minimum of 0.868 1.482 kWh/kgH2Feed (at 40.0 bar) and increases to 0.906 1.482 kWh/kgH2Feed (at 50.0 bar). However, the COP decreases over the range of P_{h,MR1} and P_{h,MR2}. This is explained by the fact that the increase of the high-pressures increases the specific heat of the mixtures at the hot side and decreases it in the cold side of the heat exchangers. This negatively affects the heat capacity of the heat exchanger and reduces the COP of the DMR process. Also, it is noted that at P_{h,MR1} less than 12.0 bar, or P_{h,MR2} less than 30.0 bar, their vapor fractions at the entrance of MRC1 and MRC2 reduce from 1.00 to 0.82 at 8.0 bar for MR1, and 0.88 at 15 bar of MR2. Therefore, higher pressures improve the quality of the mixtures at the entrance of MRC1 and MRC3 which enhance the efficiency of the compression process up to an optimum point (at which both mixtures enter the compressors at vapor fraction of 1.00). This implies that there is a trade-off between the capacity of the heat exchangers and the compression power of MRC1 and MRC2. Therefore, the high-pressure of both mixtures must be optimized to get the minimum SEC with priority for P_{h,MR2} as it composed of lighter refrigerants which demand more energy for the compression process.

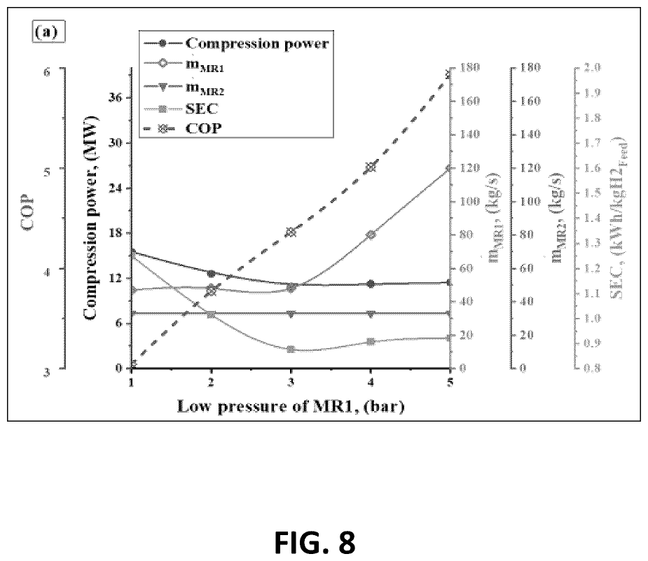

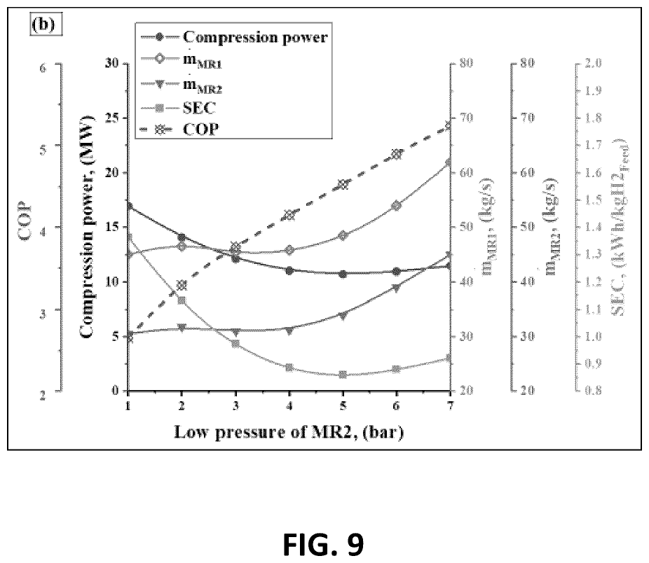

In contrast to the high-pressures of MR1 and MR2, the increase of their low-pressures reduces the compression power with slight changes in their flow rates up to optimum point (4.0 bar for MR1 and 0.0 bar for MR2) as shown in FIG. 8 and FIG. 9. Further increase in the low-pressures above the optimum values requires significant increase in the flow rates of the refrigerants to avoid the temperature-cross at the cold-end of the heat exchangers, which increase the SEC above the optimum value. However, the COP increases over the full range of the low-pressures as the heat capacity of the heat exchangers increases alongside the increase of the flow rates of both refrigerant mixtures.

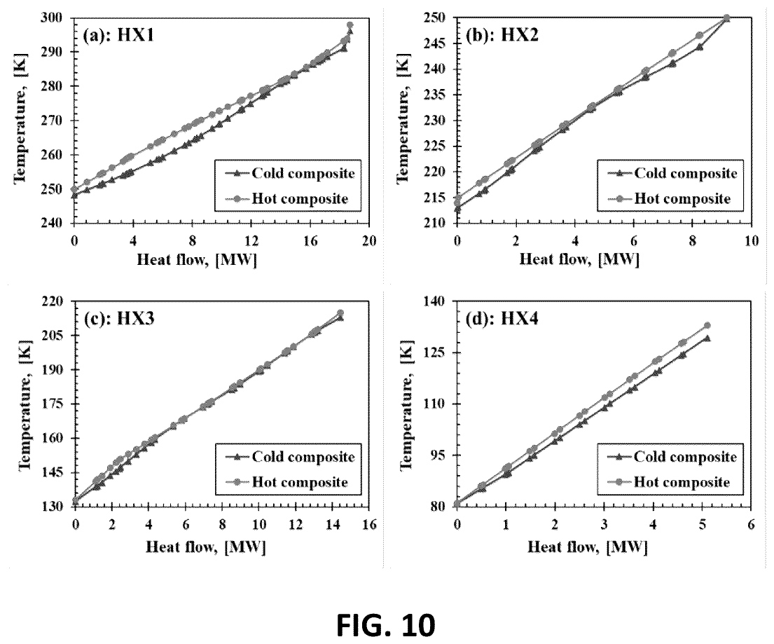

This process improves upon prior SMR processes by improving system efficiency. The composite curves of the heat exchangers obtained with MR1 and MR2 are presented in FIG. 10. It is noted that these mixtures exhibit extraordinary efficient performance as the temperature difference between the hot and cold composite curves does not exceed 5° C. as in HX1 and approaches zero as in HX3. Therefore, the energy performance of the proposed DMR is significantly improved compared to other SMR processes demonstrated in the art. The improvements over the previously known MR precooling cycles may be made further apparent through a comparison of the system to: “Introducing and Energy Analysis of a Novel Cryogenic Hydrogen Liquefaction Process Configuration” by M. S. Sadaghiani and M. Mehrpooya (herein “Reference SMR Process”). Both this system and the Reference SMR Process include the same liquefaction processes and differ only in the precooling stage. Reference SMR Process utilizes an SMR rather than a DMR.

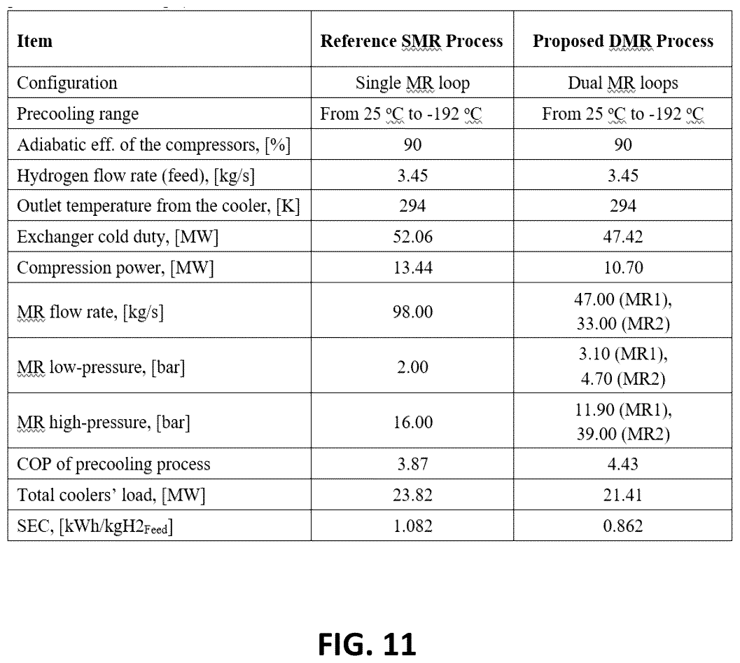

To compare the energetic performance of the proposed and the reference precooling processes, the hydrogen inlet and outlet conditions, the isentropic efficiency of the compressors, and the outlet temperatures from the coolers are set the same. The obtained results are summarized in FIG. 11. It is noted that the total flow rate of the MR1 and MR2 (80 kg/s) is less than the flow rate in the Reference SMR Process (98 kg/s). In addition, as the cold duty of HX1 (18.71 MW) and HX2 (9.16 MW) are larger than of HX3 (14.44 MW) and HX4 (5.11 MW), MR1 has higher flow rate (47 kg/s) than of MR2 (33 kg/s), However, because MR1 is compressed to 11.90 bar which is lower than of the MR2 (39.00 bar) and the components of MR1 are heavier by molecular weight than of MR2, the compression power of MR1 (4.01 MW) is 40% less than of MR2 (6.69 MW) in the proposed DMR process. This implies that the proposed DMR process provides flexibility in the distribution of quantity (amount of heat absorbed) and quality (level of temperature) of the cold duty through the heat exchangers, which is not feasible by using Reference SMR Process. This means that the operation of the DMR process is more efficient than that of the Reference SMR Process.

From energy point of view, this was proved by comparing the specific energy consumption (“SEC”) and the coefficient of performance (“COP”) of both processes, as shown in FIG. 11. It is found that the SEC of the DMR process (0.862 kWh/kgH2Feed) is less than that of the Reference SMR Process (1.082 kWh/kgH2Feed) by 20.33%. At a hydrogen flow rate of 3.45 kg/s, the total compression power is reduced from 13.44 MW in the Reference SMR Process to 10.70 MW in the DMR process. Also, the total cold duty of the heat exchangers is reduced from 52.06 MW (in SMR) to 47.42 MW (in DMR). Therefore, the COP of the DMR process (4.43) is higher than of the Reference SMR Process (3.87) by 14.47%. As the total cold duty and total compression power of the DMR are significantly less than of the SMR, this will minimize the capital and operational costs of the DMR process.

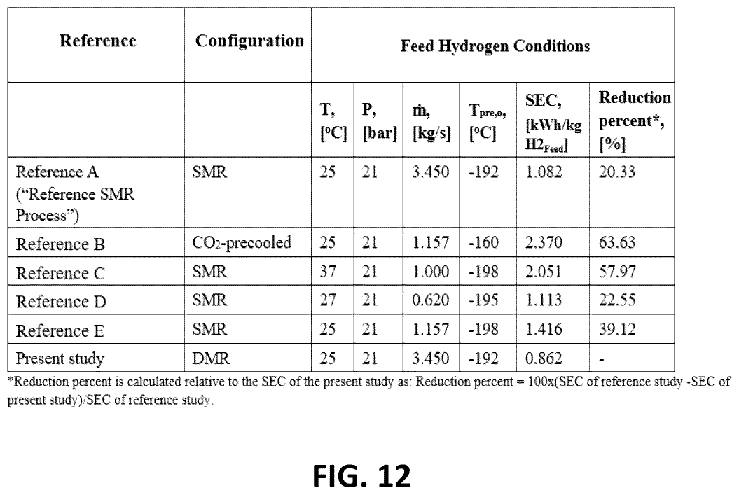

Despite the efficient performance of the proposed DMR compared to the Reference SMR Process, it is worthwhile to compare its capacity and SEC with other hydrogen precooling processes available in the literature as shown in FIG. 12. The following references are compared in FIG. 12: (A) “Introducing and Energy Analysis of a Novel Cryogenic Hydrogen Liquefaction Process Configuration” by M. S. Sadaghiani and M. Mehrpooya (“Reference A”); (B) “Carbon-Dioxide-Precooled Hydrogen Liquefaction Process: An Innovative Approach for Performance Enhancement-Energy, Exergy, and Economic Perspectives” A. Naquash, M. A. Qyyum, S. Min, S. Lee, M. Lee (“Reference B”); (C) “Large-Scale Hydrogen Liquefier Utilising Mixed-Refrigerant Pre-Cooling” by D. O. Berstad, J. H. Stang, P. Neksi (“Reference C”); (D) “A Novel Integrated Structure of Hydrogen Purification and Liquefaction Using Natural Gas Steam Reforming, Organic Rankine Cycle and Photovoltaic Panels” by B. Ghorbani, M. Mehrpooya, M. Amidpour (“Reference D”); and (E) “Optimal Operation of a Large-Scale Liquid Hydrogen Plant Utilizing Mixed Fluid Refrigeration System” by S. Krasae-In (“Reference E”).

It is found that the proposed DMR process is superior to other SMR processes. There are huge differences between the SEC of the proposed DMR process and of that used CO2 as a pure refrigerant in Reference B or the SMR presented in Reference C by 63.63%, and 57.97%, respectively. In addition, the precooling target temperature of the process in Reference B is −160° C. compared to lower than −190° C. of the other listed processes. This implies that the mixed refrigerant processes have superior performance compared to pure refrigerant processes. Although the process in Reference C is a SMR process and its hydrogen flow rate is only 1.00 kg/s (70% lower than in the present study), the selected components of its refrigerant mixture contain R-14, Neon, and n-Butane which form 20% of the mixture compositions. These refrigerants, as noted during the development of the new proposed refrigerants in this study, increase the compression power with a slight improvement in the heat exchanger performance.

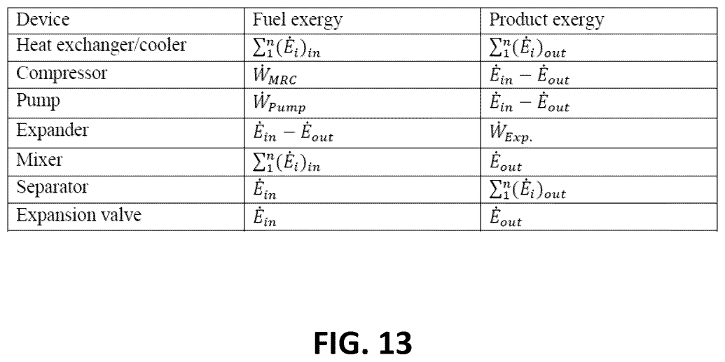

Exergy efficiency related to the proposed DMR process was calculated by the summation of the physical exergy in each stream on the process plus the chemical exergy of each stream on the process. Physical exergy, Ėᵢ^{ph}, is defined as:

$${\dot{E}}_{i}^{p h} = {\dot{m}}_{i} [ ( {h}_{i} - {h}_{o} ) - {T}_{o} ( {s}_{i} - {s}_{o} ) ]$$

where hₒ and sₒ refer to the enthalpy and entropy of the flow at ambient temperature and pressure (dead state), respectively. Chemical exergy, is defined as:

$${\dot{E}}_{i}^{c h} = \sum ( {x}_{j} {\dot{E}}_{J}^{O} ) + \dot{G} - \sum ( {x}_{j} {G}_{i} )$$

where xⱼ, Ėⱼ^{O}, and Ġ stand for the mole fraction of component j, standard chemical exergy of component j, and the Gibbs free energy rate, respectively. FIG. 13 includes the definitions of fuel exergy and product exergy related to the equipment for the DMR precooling process.

The analysis revealed that the overall exergy efficiency is 98.30% which is 6.14% higher than the Reference SMR Process (92.610%). This high exergy efficiency is achieved as all the heat exchangers, compressors, and coolers of the new DMR precooling process have exergy efficiencies higher than 90%. Furthermore, the number of the separators and mixers is reduced compared to the Reference SMR Process which further enhances the exergy efficiency of the present DMR process. Moreover, while the liquid expanders provide additional power (206 kW) in the reference process, their exergy efficiencies are the lowest compared to the other components which negatively affects the overall exergy efficiency of the Reference SMR Process. At the design point conditions, the total input exergy, product exergy, and exergy destruction are 297.22 MW, 292.16 MW, and 5.06 MW, for the DMR process and 350.16 MW, 324.28 MW, and 25.88 MW for the Reference SMR Process, respectively.

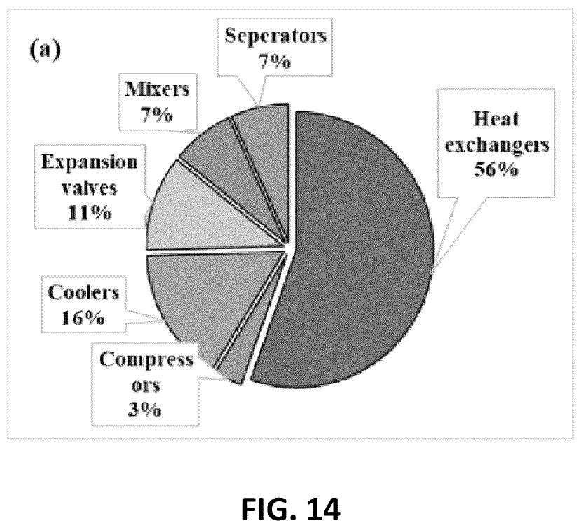

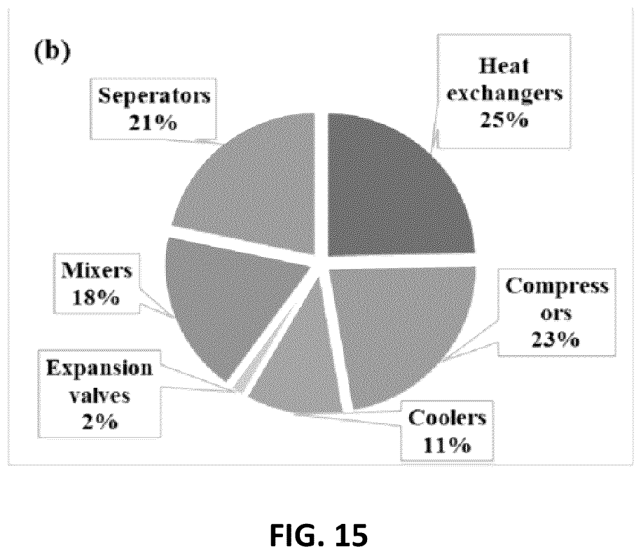

The contributions of the proposed DMR process equipment to the product exergy and exergy destruction is presented in FIGS. 14 and 15, respectively. Heat exchangers have the lion share in contribution of product exergy (56%) and the highest exergy destruction part (25%) of all components as well. Furthermore, the contribution of separators and mixers to the total exergy destruction is larger than of their contribution to the total exergy product. The high exergy efficiency of the precooling process is much higher than of the liquefaction process (52.24%) as the liquefaction process is conducted at extremely low temperature with lighter refrigerants. However, enhancing the exergy efficiency of the DMR precooling cycle could enhance the exergy efficiency of the overall liquefaction process.

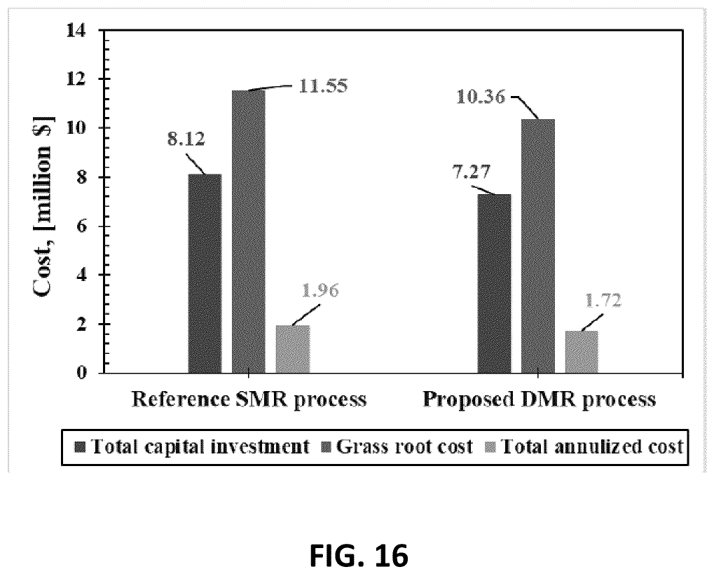

Further, the proposed DMR process would provide economic benefits over other hydrogen precooling processes such as the Reference SMR Process. The economic evaluation of the proposed DMR process and the Reference SMR Process is conducted in terms of the total capital investment (“TCI”), grass root cost (“GRC”), and the total annualized cost (“TAC”) and presented in FIG. 16. The TCI, GRC, and TAC are calculated by:

$$TCI = 1. 18 \times {\sum }_{k}^{m} {C}_{BM , k}$$

$$GRC = TCI + 0. 5 \times {\sum }_{k}^{m} {C}_{BM , k}$$

$$TAC = \frac{T C I}{P B P} + OC$$

where PBP is the payback period (set at 5 years), OC is the operational cost of each process, and C_{BM,k} is the cost of the base module. OC is calculated by:

$$OC = electricity cost ( \$ / kW \cdot yr ) \times ( \sum {\dot{W}}_{M R C , i} - {\dot{W}}_{Exp , i} ) ( kW )$$

and C_{BM,k} is calculated by:

$${C}_{BM , k} = {E}_{p , k} \times {F}_{BM , k}$$

where F_{BM,k} is the module cost factor (set at 1.0) and E_{p,k} is determined by:

$${log}_{10} ( {E}_{p , k} ) = {K}_{1} + {K}_{2} \times {log}_{10} ( A ) + {K}_{3} \times {( {log}_{10} ( A ) )}^{2}$$

where K₁, K₂, and K₃ are cost constants and A is a capacity parameter.

The capital cost of the miscellaneous components (mixers, separators, and control valves excluding the expanders that were considered as major components) is calculated by the authors for several similar cycles and found to be about 1.00% of the total costs of the other components in the Reference SMR Process. For the proposed DMR process, a conservative 2.00% is used, which accounts for the control valves that replaced the liquid expanders used in SMR and accounts for the expansion valves. Furthermore, the payback period was set to five years and the plant maintenance cost is fixed at 2.00% of the TCI. From FIG. 16, it is found that the TCI, GRC, and TAC of the present DMR process are lower than of the reference SMR process by 10.46%, 10.30%, and 12.24%, respectively.

The reduction of costs achieved by the DMR process can be explained by the following reasons: (1) the total cold duty of the heat exchangers in the DMR process (47.42 MW) is reduced by 8.91% compared to the Reference SMR Process (52.06 MW), which reduces the capital costs of the heat exchangers; (2) as the total flow rate of MR1 and MR2 in the DMR process (80 kg/s) is lower than in the Reference SMR Process (98 kg/s), the total coolers' load is reduced by 10.110% (from 23.82 MW in the Reference SMR Process to 21.41 in the proposed DMR process), which reduces the capital cost of the coolers; (3) the DMR process utilizes control valves for the expansion process rather than the more expensive liquid expander which further reduces the TCI; and (4) the compression power in the DMR (10.70 MW) is less than in the SMR (13.44 MW) by 20.40%, which significantly reduces the operational cost of the DMR process (from 0.34 million $/year in the SMR to 0.27 million $/year in the DMR process).

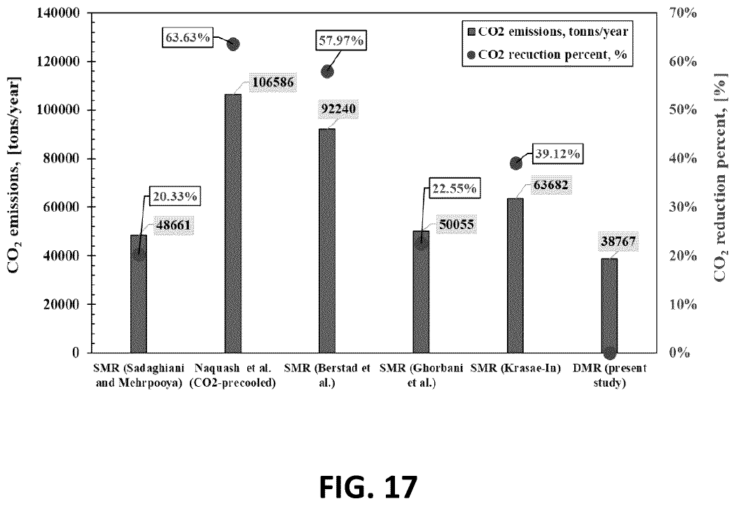

The proposed DMR process also includes environmental benefits. As renewable sources suffer from several issues such as limited abundancy, fluctuations, and high capital investment, the utilization of the fossil-fuel-based energy seems to be unavoidable. Thus, minimizing the SEC of the generation and liquefaction processes is essential to reduce their CO2 emissions. Assuming the precooling process is driven using fossil-fuel-based energy (electricity), the CO2 emissions of the present DMR process is compared with other pure-refrigerant and SMR precooling process as shown in FIG. 17. It presents the annual CO2 emissions of the present DMR process compared to the other precooling processes reported in FIG. 17. The amount of CO2 emissions is calculated in tons per year basis assuming the electricity is provided from natural gas power plant with emission amount of 0.411 tons/MWhe. It is found that the proposed DMR process proposed in the present study reduces the CO2 emissions by 20.33% to 63.63% compared to all other five technologies.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A process for hydrogen liquefaction, the process comprising:
providing a first cooling loop with a first mixed refrigerant; and
providing a second cooling loop with a second mixed refrigerant.

2. The process of claim 1, wherein the first cooling loop comprises at least a first heat exchanger and a second heat exchanger.

3. The process of claim 1, wherein the second cooling loop comprises at least a third heat exchanger and a fourth heat exchanger.

4. The process of claim 1, wherein the first cooling loop comprises at least a first cooler and a second cooler.

5. The process of claim 1, wherein the second cooling loop comprises at least a third cooler, a fourth cooler, and a fifth cooler.

6. The process of claim 1, wherein the first cooling loop comprises at least a first expansion valve and a second expansion valve.

7. The process of claim 1, wherein the second cooling loop comprises at least a third expansion valve and a fourth expansion valve.

8. The process of claim 1, wherein the first cooling loop comprises at least a first mixed refrigerant compressor and a second mixed refrigerant compressor.

9. The process of claim 1, wherein the second cooling loop comprises at least a third mixed refrigerant compressor, a fourth mixed refrigerant compressor, and a fifth mixed refrigerant compressor.

10. The process of claim 1, wherein the first cooling loop comprises at least a first mixer.

11. The process of claim 1, wherein the second cooling loop comprises at least a second mixer.

12. The process of claim 1, wherein the first cooling loop comprises at least a first separator.

13. The process of claim 1, wherein the second cooling loop comprises at least a second separator.

14. The process of claim 1, wherein the first mixed refrigerant comprises at least one of Methane, Ethane, Propane, n-Butane, i-Pentane, n-Pentane, Nitrogen, Hydrogen, Ethylene, R-14, or Ammonia.

15. The process of claim 1, wherein the second mixed refrigerant comprises at least one of Methane, Ethane, Propane, n-Butane, i-Pentane, n-Pentane, Nitrogen, Hydrogen, Ethylene, R-14, or Ammonia.

16. The process of claim 1, wherein the first mixed refrigerant has a heavier molecular weight than the second mixed refrigerant.

17. The process of claim 1, wherein the first mixed refrigerant is in a vapor phase and liquid phase in the first cooling loop.

18. The process of claim 1, wherein the second mixed refrigerant is in a vapor phase and a liquid phase in the second cooling loop.
